(19) United States
(12) Patent Application Publication
(10) Pub. No.: US 2026/0355622 A1
(43) Pub. Date: Nov. 12, 2026

(54) Ergonomic Modular Video Game Controller

(71) Applicant: COGITO LLC, Las Vegas, NV (US)

(72) Inventors: Travis Mow, Henderson, NV (US); David Michael Rowley, Monroe, WA (US)

(21) Appl. No.: 19/738,780

(22) Filed: Jul. 13, 2026

Related U.S. Application Data
(63) Continuation-in-part of application No. 19/674,047, filed on May 11, 2026.
(60) Provisional application No. 63/803,189, filed on May 9, 2025.

(51) Int. Cl. A63F 13/24; A63F 13/211; A63F 13/235

(52) U.S. Cl. CPC A63F 13/24; A63F 13/211; A63F 13/235

(57) ABSTRACT

An ergonomically enhanced video game style controller. The controller allows a user to fully operate the controls without removing their hand from the individual buttons or contorting their hands. Further, the controller is constructed such that the thumb and each digit on each hand may operate a separate button or control stick. The controller is functionally split between two mirrored hand units and optionally allows for a bridge between these units, to control the width of the controller. This allows the controller to promote a more natural resting posture during play or operational sessions. The hand units may be configured to function in direct coordination with one another, similar in manner to a traditional game controller with a single electronic control component. Alternately, the controller may be configured for each hand unit to communicate directly and independently with the game system or other device to coordinate the controller functions.

### FIELD OF THE INVENTION

The present invention relates generally to video game peripherals. More specifically, the present invention is an ergonomically designed video game controller.

### BACKGROUND OF THE INVENTION

Conventional video game controllers often fail to address prolonged user comfort and natural hand posture. The standard configurations place the primary action buttons, directional pads (d-pads), and analog thumb sticks in positions that require repeated overextension of the thumbs and awkward wrist angles, especially when partaking in extended gaming sessions. This can lead to user fatigue, strain injuries, and reduced performance while gamers can feel these developments over either extended or relatively short time periods.

One contributing element is how most existing controllers tend to concentrate all interactive components on the front-facing surface. This generally requires the user to move away from the action buttons or analog sticks to utilize the other control element. This structure can be viewed as a flaw, which limits simultaneous input capabilities and diminishes competitive gaming performance through the motion requirements for utilizing the full potential range of controls.

To compensate, many competitive and/or professional players will gravitate towards using a mouse and keyboard arrangement when possible, for greater access to additional buttons. Alternately, these players will utilize larger control devices (often referred to as arcade sticks or fighting joysticks), preferring to rest them on a surface while hovering over the buttons and joystick. This is particularly popular in the community around the fighting game genre, one of the more dexterously demanding uses for game controls.

Non-gaming uses include the installation of video game controllers to operate DIY and remote vehicles, such as submersibles and non-automated drones (whether land-based, aerial, or seaborne). In environments where extended or precise use may be necessary, many of the same and similar concerns can arise. For example, an aerial drone may require constant activity on twin thumb-sticks to operate separate axis of control. Should that drone require additional operation of enough instruments, such as cameras and activated sensors, the button input requirements can be characterized similarly to the complex inputs of certain video game genres.

The present invention addresses these considerations while offering an ergonomic structure which facilitates simultaneous input functionality. Further, the invention accommodates diverse hand dominance by providing a symmetrical layout which may be customized through software and/or firmware. Additionally, the invention may offer some comfort and accessibility option, such as a modular bridge so that the input elements of the controller are held stably at a comfortable shoulder width. Importantly, the invention allows a user to hold the device in a traditional grip while employing all ten digits for a programmable function with zero or limited extension necessary in gameplay.

### BRIEF SUMMARY OF THE INVENTION

The invention is an ergonomic and modular video game controller designed to reduce physical strain and enhance gaming performance by aligning with the natural contours and movement range of the human hand. The controller features symmetrical left and right halves connected optionally by a center bridge that widens the grip and improves spinal posture. Each half includes analog thumb sticks, directional pads, a utility button, and rear-mounted finger buttons that allow simultaneous use of thumbs and fingers. Magnetic connectors, alignment pins, bushings, and pogo pin contacts enable secure assembly and electrical connectivity. The design improves comfort, response time, and hand health during extended gameplay sessions.

Ergonomic Modular Video Game Controller introduces a more efficient and more comfortable controller that can be used for video games. The controller design accommodates better posture while operating for extended durations. The benefits from using this more ergonomically designed controller leads to improved comfort, spinal and joint health. This design is intended to reduce hand strain and tension, which would otherwise result from having to reach beyond the natural range of motion that would be comfortable to operate the controller’s thumb sticks, d-pads, and buttons. The contours of the controller grips (as well as the locations of the thumb sticks, d-pads, and buttons) are designed to accommodate the human hand in its most comfortable and natural relaxed position. The design achieves minimal finger/thumb travel distance and movement, thus achieving quicker response times, less strain on the hand and joints, and less likelihood of cramping of the hands or fingers when operating for extended periods of time. The removable center bridge enables wider grip positioning that allows comfortable operation in a variety of body positions.

The design is based on a “natural mapping” approach to be more comfortable and accommodate the human hand in terms of the natural grip contours, as well as thumb stick, d-pad, and button locations. This design accommodates the unique and complex shape of the human hand. The design consists of one button for each finger on each hand, located in a natural position, accommodating the different lengths of each finger, on the back side of the controller (vs. the current mainstream design of existing controllers where the main buttons are designed to be operated with the thumb, and located on the front of the controller). The controller also has symmetrically positioned dual analog thumb-sticks and directional pads (d-pads) located in a more natural position based on the shape of the human hand. The symmetric design of the left and right halves of the controller allows the design to accommodate left-handed, right-handed, and ambidextrous operation with equal comfort and convenience.

The placement of the buttons on the back side of the controller, and the thumb sticks and d-pads on the front side of the controller, allow the user to operate the thumb sticks and buttons simultaneously, or operate the d-pads and buttons simultaneously. One could also operate a thumb stick with one thumb and a d-pad with the other thumb, while pressing any or all of the 8 buttons on the back side of the controller simultaneously as well. (Conventional or mainstream video game controllers have the main buttons on the right front side, as well as the thumb sticks and d-pad in close proximity. This positioning of thumb sticks, d-pads, and buttons all on the front side requires a person to take their thumb off the right thumb stick to press any of the buttons on the right front side of the controller. This results in a person not being able to control the right thumb stick and press the buttons located on the front side of the controller, next to the right thumb stick simultaneously.)

Thumb sticks traditionally control movement and buttons traditionally activate functions in the majority of video games. There is a competitive advantage created by using this controller, in that the buttons can be pressed with the fingertips at the same time the thumb is controlling the thumb sticks, or d-pads, with each hand simultaneously. (In video games the faster you can press a button compared to your opponent, the more competitive advantage you have. In our controller design, the time spent alternating between thumb stick and button pressing with the thumb is eliminated because all 8 fingertips are in contact with all 8 buttons at all times, resulting in faster response times.)

In terms of comfort, the contours of the grips of the controller are molded from and shaped to accommodate the natural contours of the palm of the human hand. This controller is designed to be held and stabilized in the hands through the natural pressure of the palms pressing inward towards each other, while holding the controller in the hand, and not gripped or held through the use of any fingers. This allows the fingers to be free of the task of gripping the controller to hold it in place, such that they are free to operate the buttons on the back of the controller in the same manner a piano player’s fingers would be free to press the keys on a piano. The controller shell/enclosure is extruded on the back side near the buttons to act as a button guard and prevent the buttons from unintentionally being pressed if dropped and protect the buttons from potential damage in the same scenario. This extrusion also serves as “resting rails” so the controller can be laid to rest or stored in a position lying flat on its back when not in use and preventing the buttons from coming in contact with the surface the controller is resting on.

The invention may also include a bridge. The bridge functions as a spacer that maintains and continues electrical connectivity while also allowing the left and right halves of the controller to be positioned further apart from each other. This wider grip while operating the controller is more comfortable to operate while leaning back (vs. being hunched forward over traditionally designed controllers, due to the requirement for such a narrow grip inherent in their design). Our controller allows the operator to be in a position where their shoulder blades are able to be closer together, due to the wider grip distance (approximately shoulder width), resulting in a higher degree of comfort and improved spinal health.

### BRIEF DESCRIPTION OF THE DRAWINGS

FIG. 1 is a front, right upper side off-set view for an embodiment of the present invention.

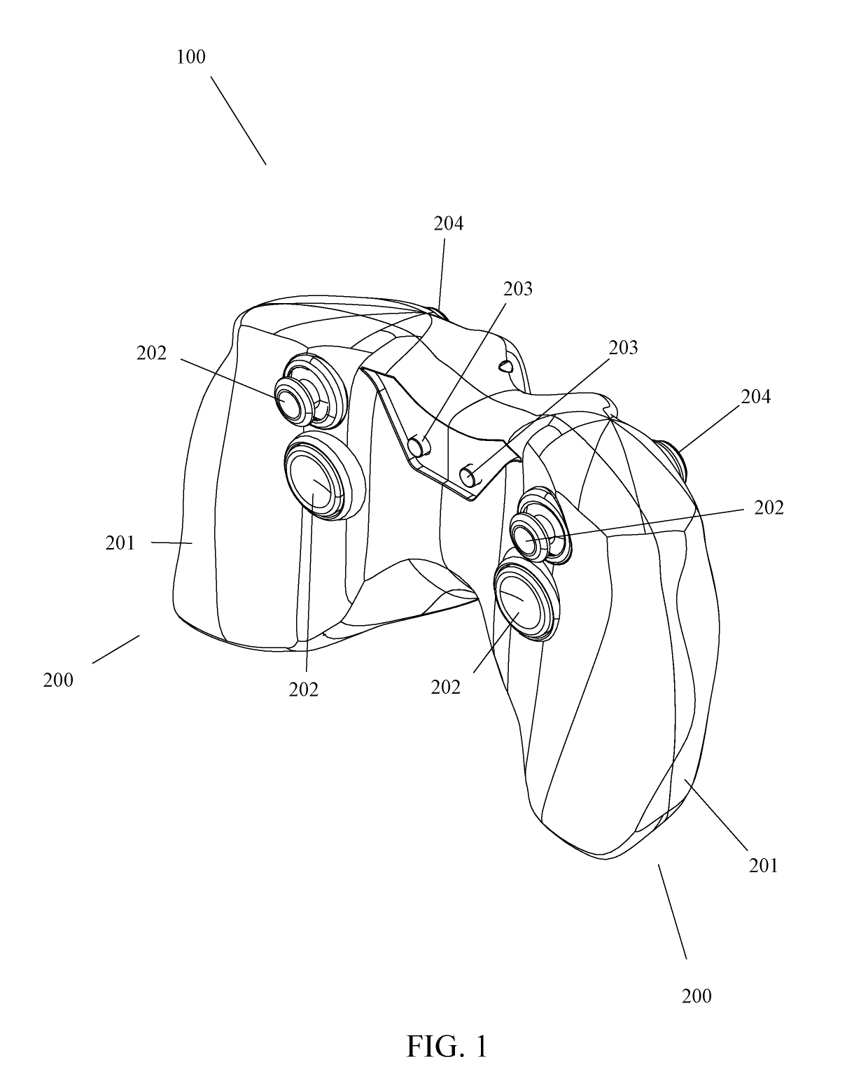

FIG. 2 is a rear, left lower side off-set view for an embodiment of the present invention.

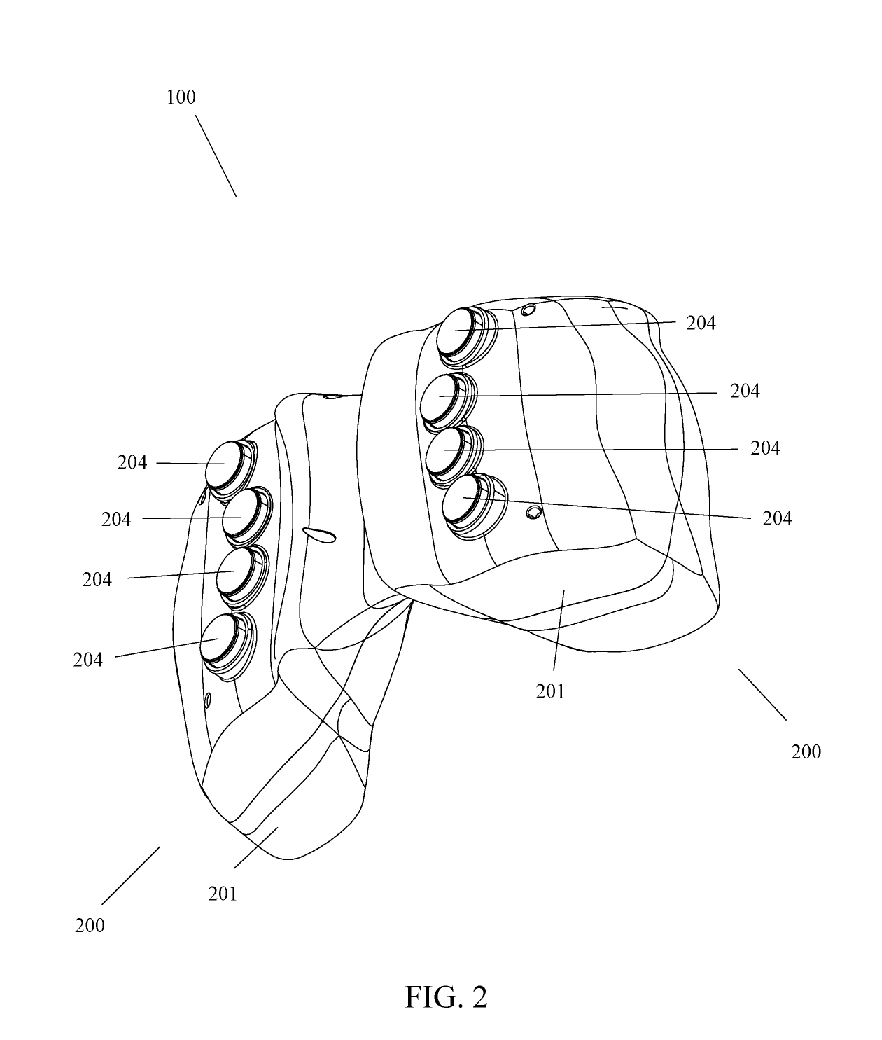

FIG. 3 is a front side view for an embodiment of the present invention.

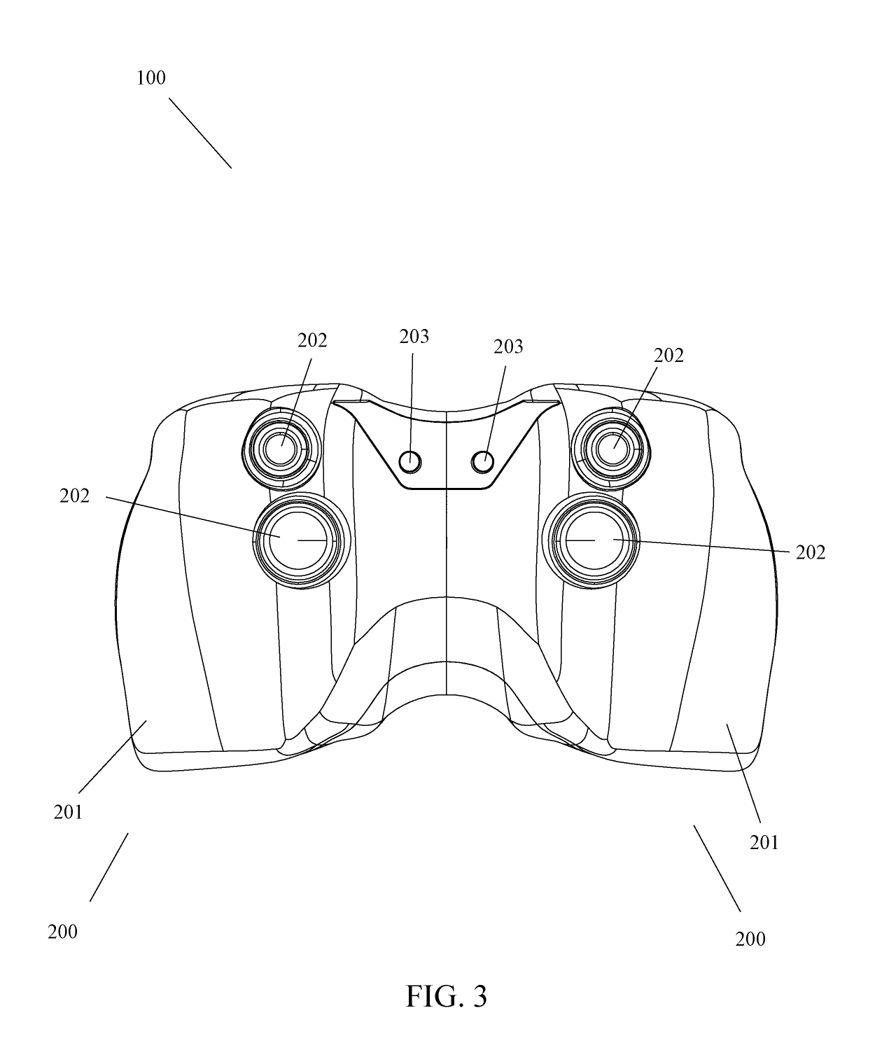

FIG. 4 is a rear side view for an embodiment of the present invention.

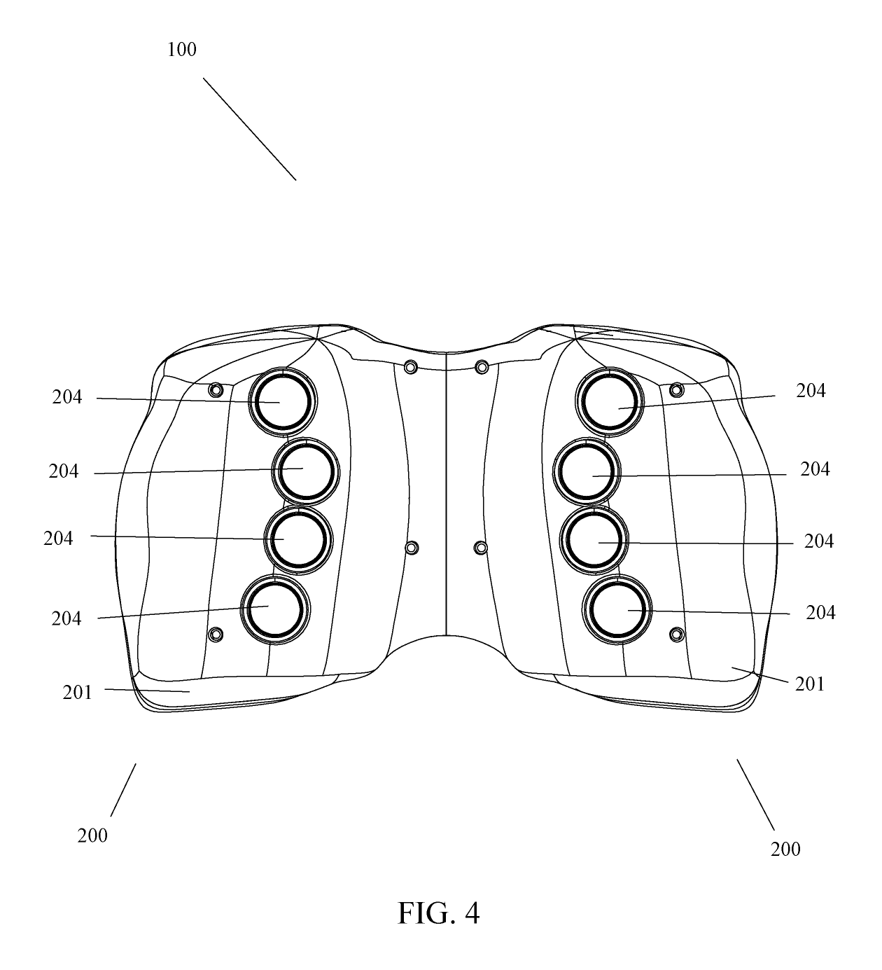

FIG. 5 is a top side view for an embodiment of the present invention.

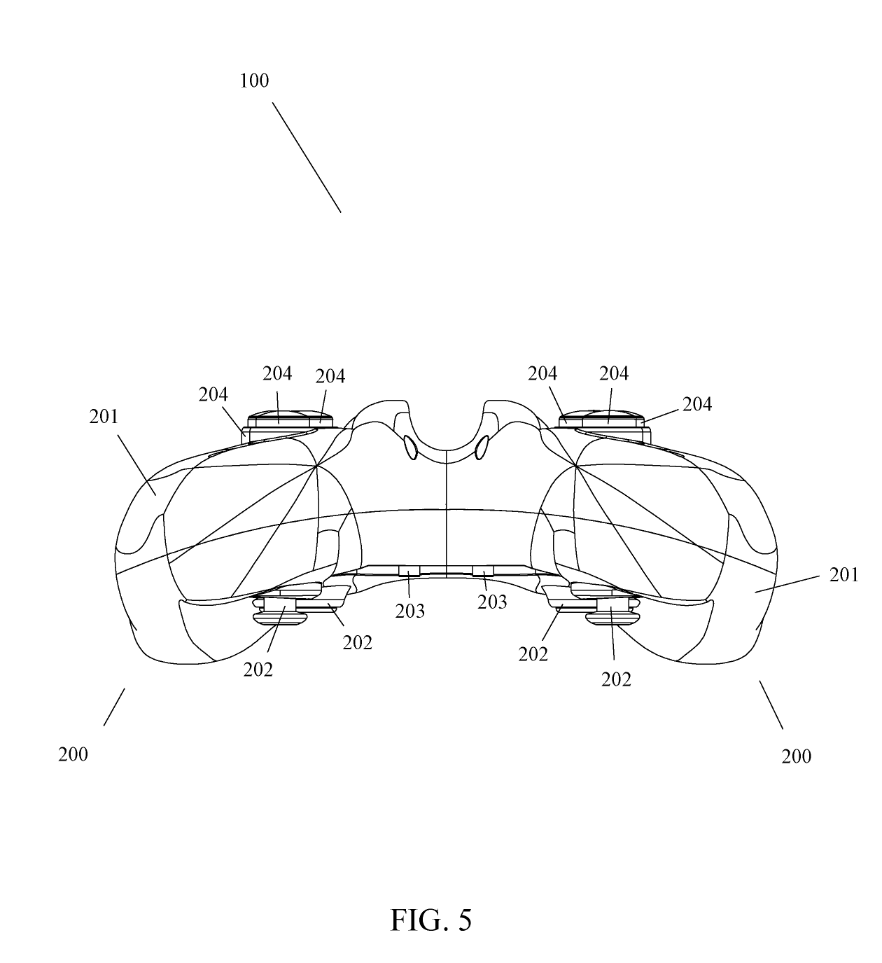

FIG. 6 is a bottom side view for an embodiment of the present invention.

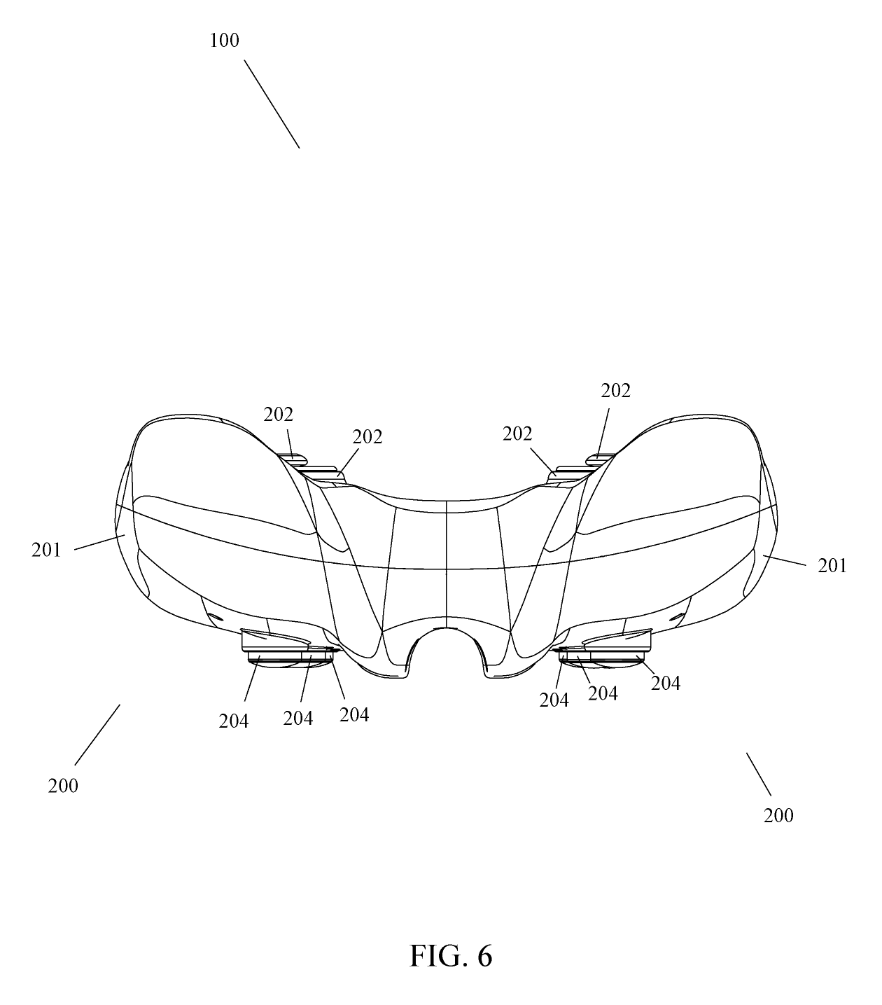

FIG. 7 is a left side view for an embodiment of the present invention.

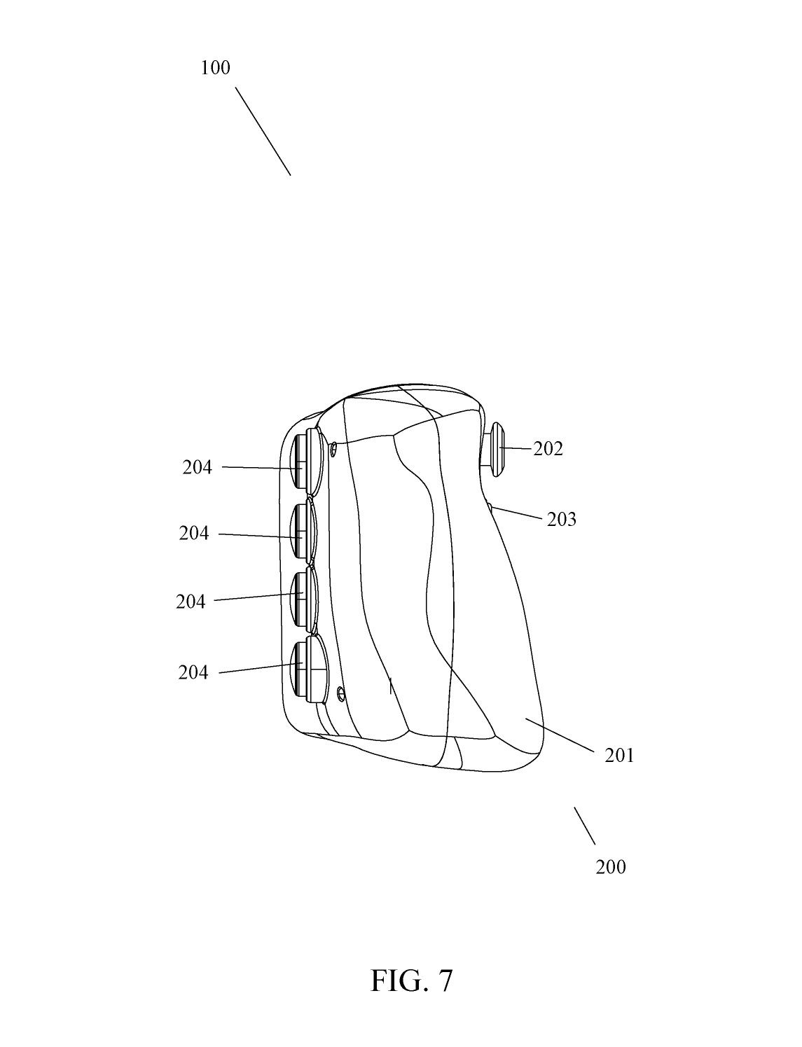

FIG. 8 is a right side view for an embodiment of the present invention.

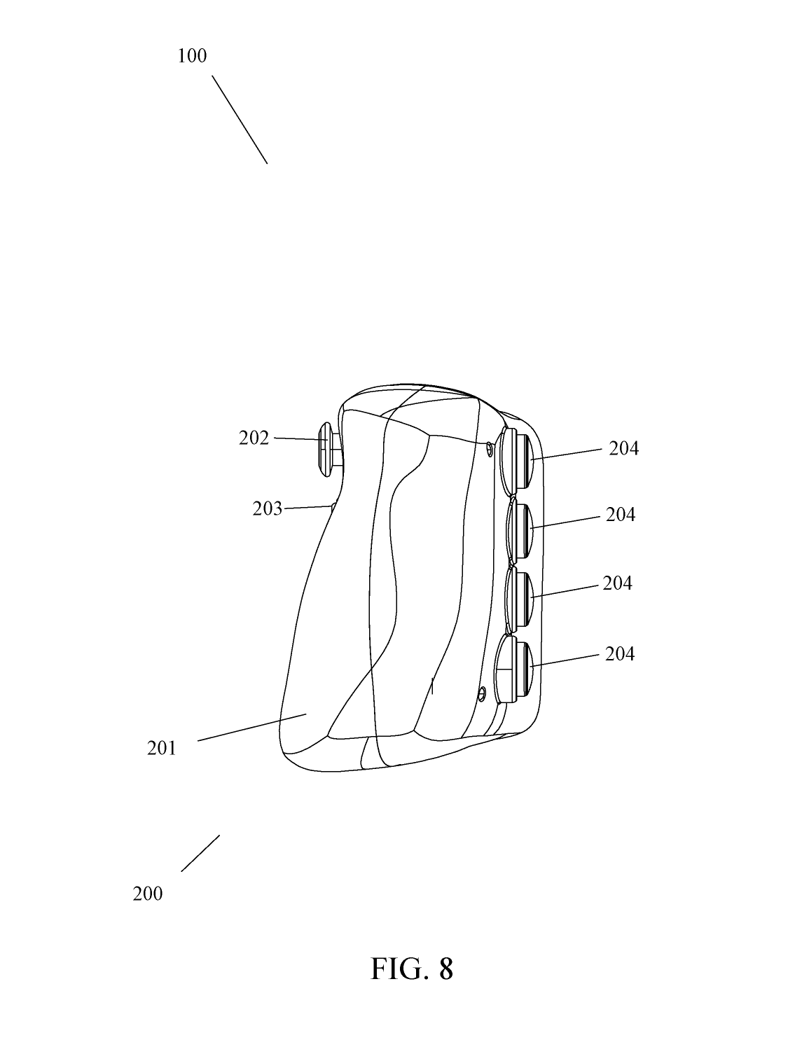

FIG. 9 is a front, right upper side off-set view for an embodiment of the present invention, where a version of the modular bridge is installed.

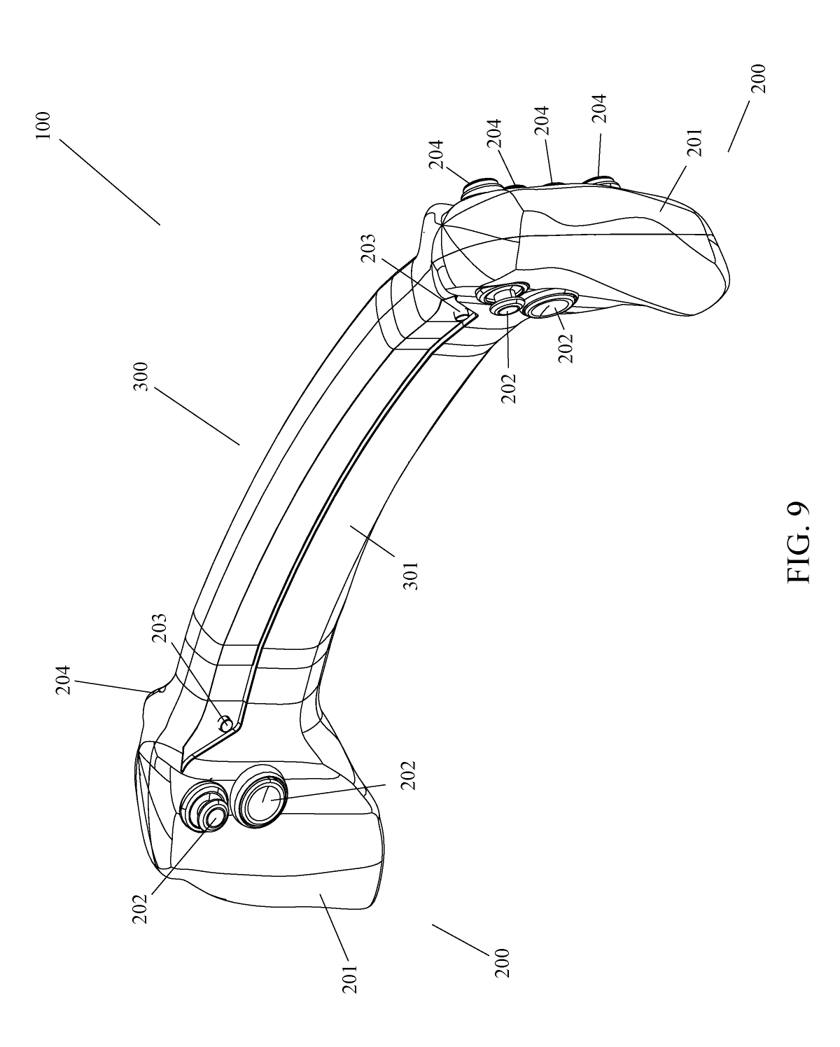

FIG. 10 is a rear, left lower side off-set view for an embodiment of the present invention, where a version of the modular bridge is installed.

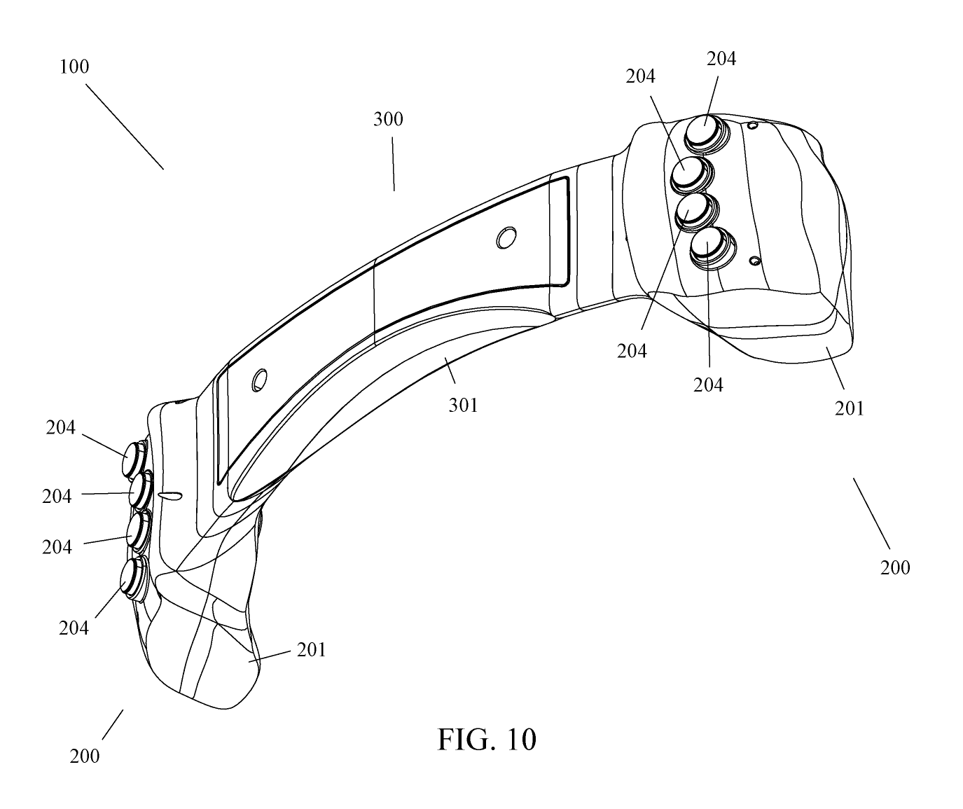

FIG. 11 is a front side view for an embodiment of the present invention, where a version of the modular bridge is installed.

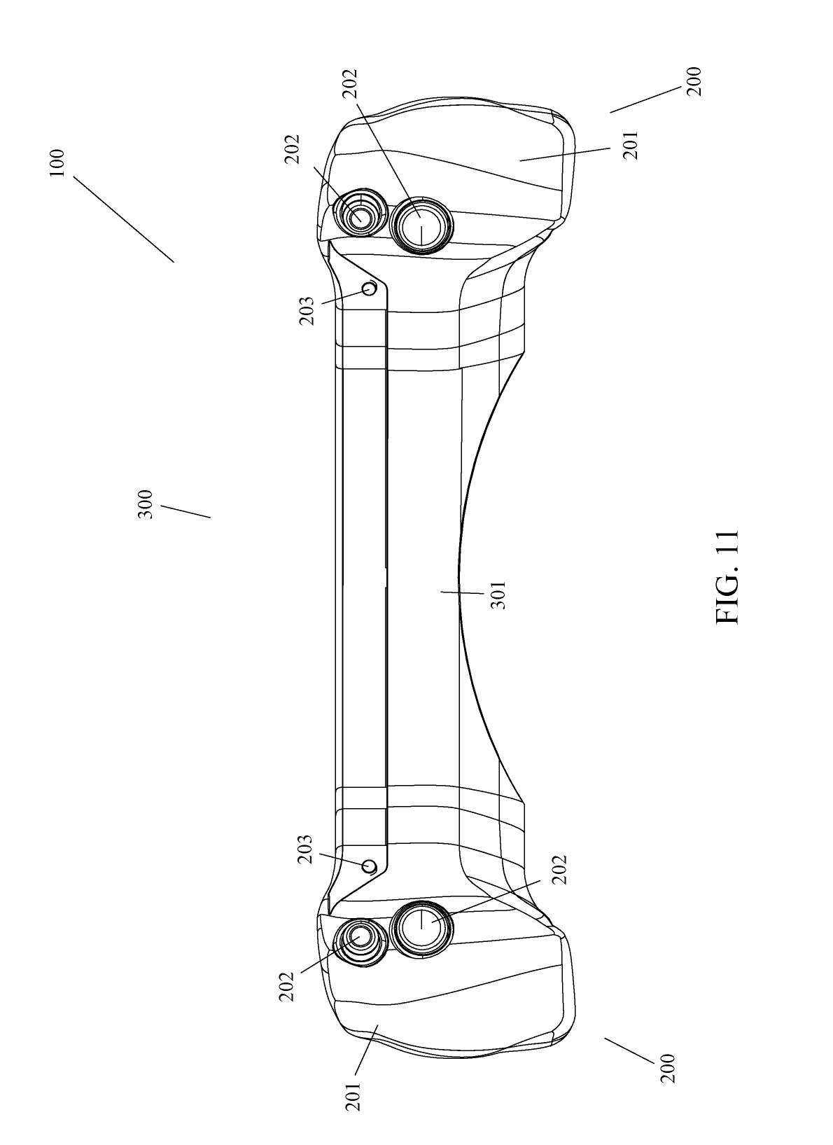

FIG. 12 is a rear side view for an embodiment of the present invention, where a version of the modular bridge is installed.

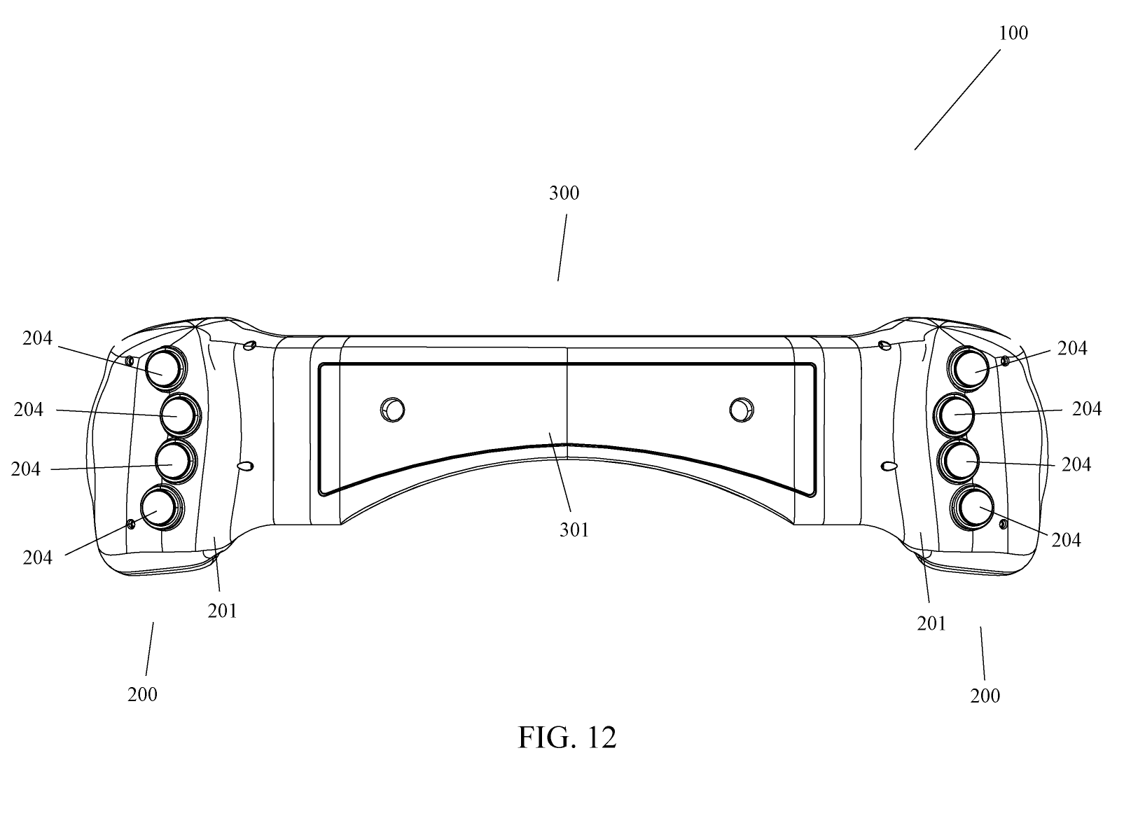

FIG. 13 is a top side view for an embodiment of the present invention, where a version of the modular bridge is installed.

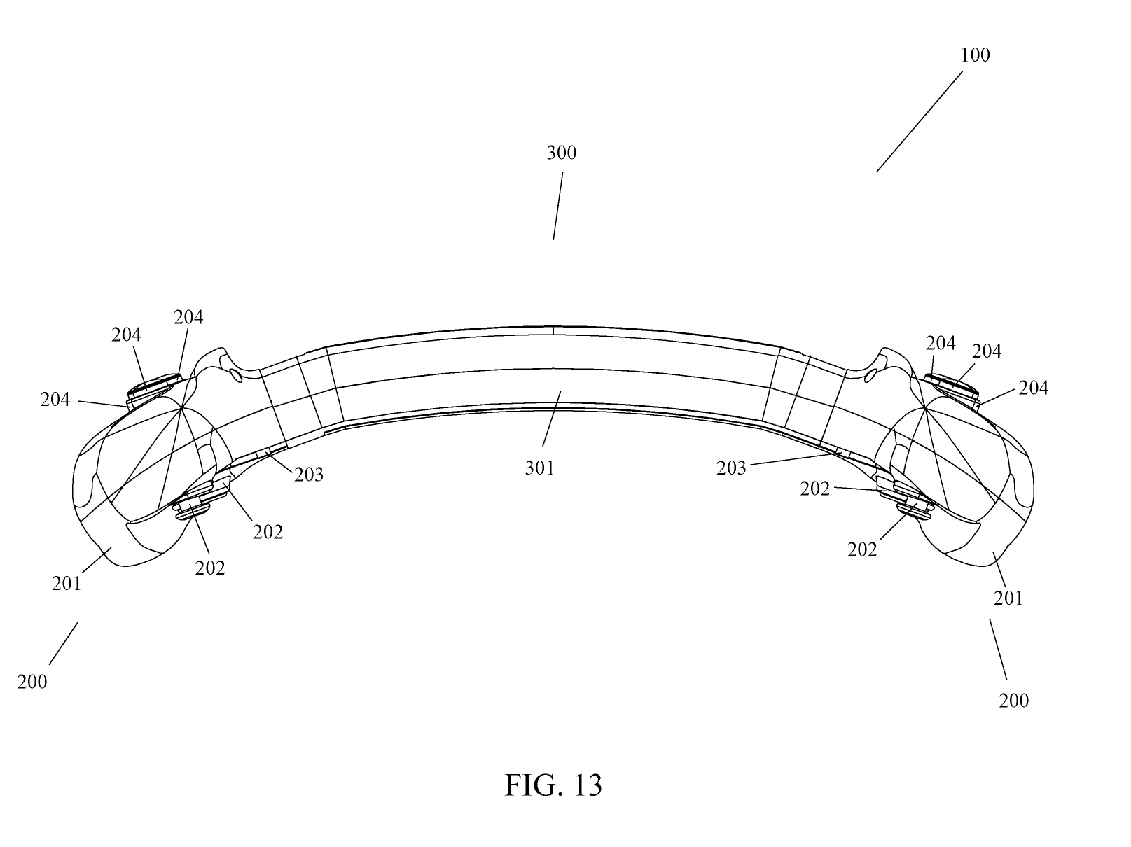

FIG. 14 is a bottom side view for an embodiment of the present invention, where a version of the modular bridge is installed.

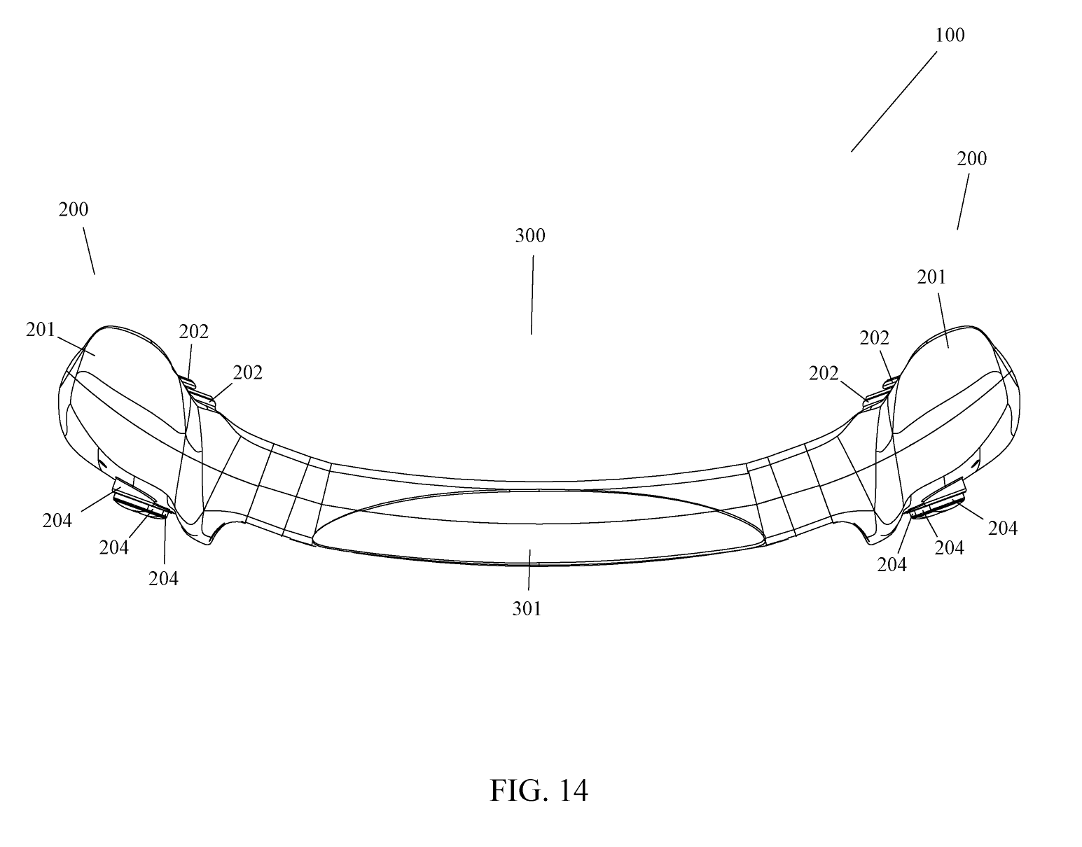

FIG. 15 is a left side view for an embodiment of the present invention, where a version of the modular bridge is installed.

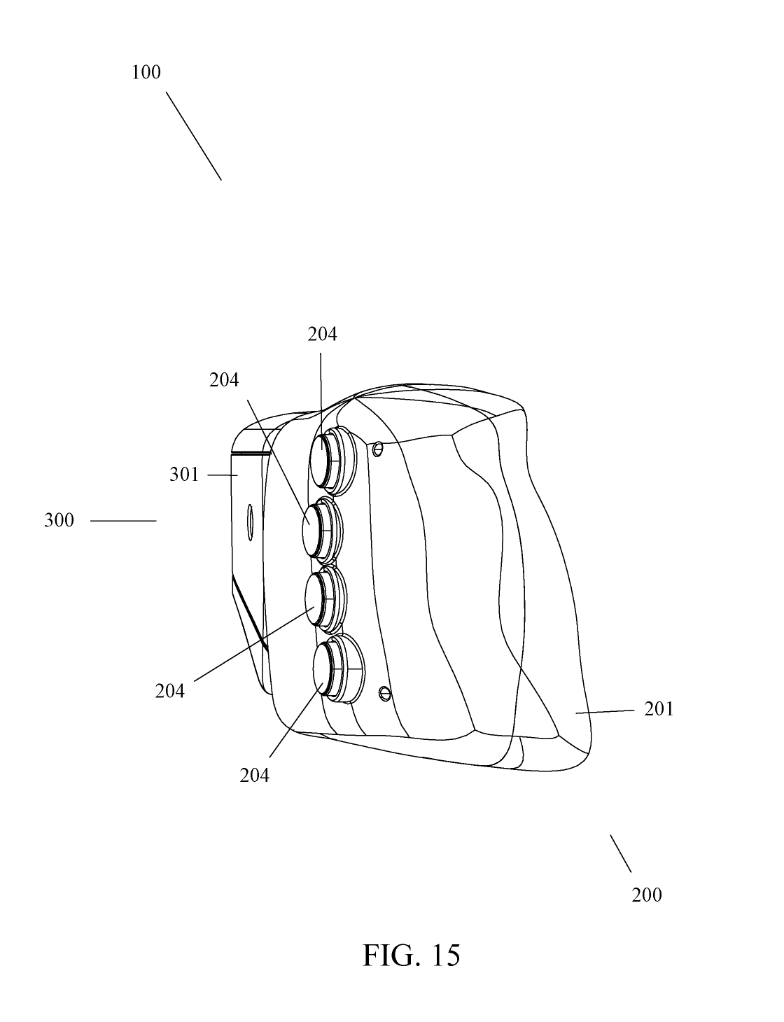

FIG. 16 is a right side view for an embodiment of the present invention, where a version of the modular bridge is installed.

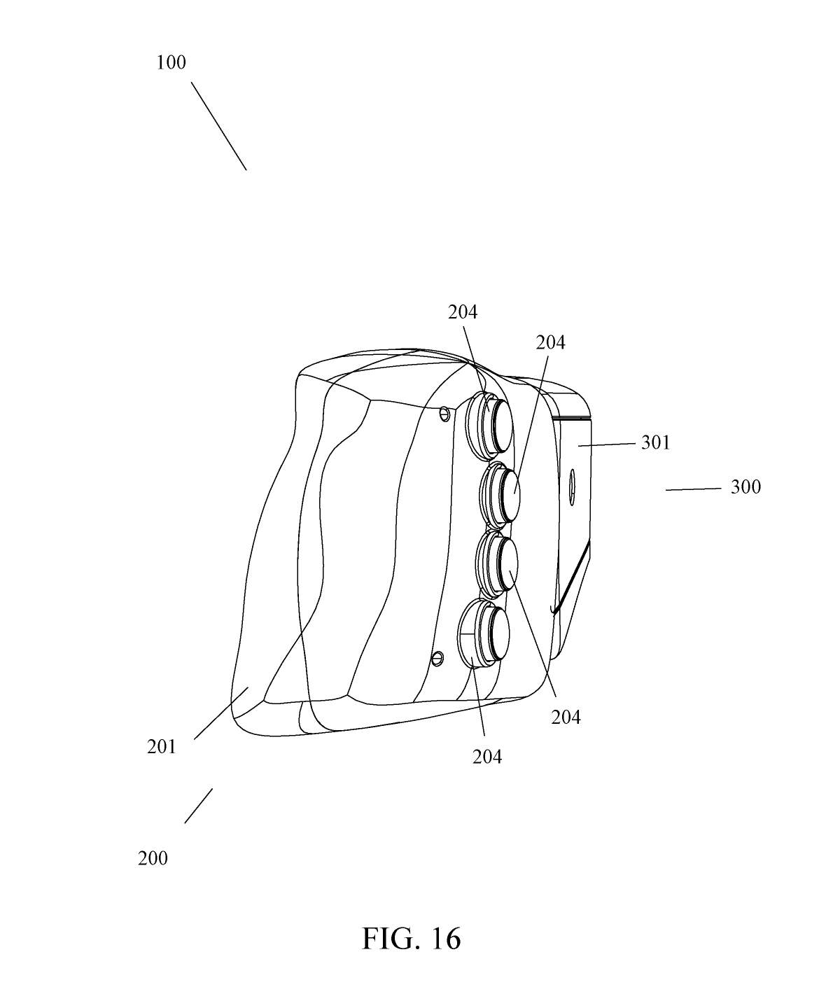

### DETAIL DESCRIPTIONS OF THE INVENTION

All illustrations of the drawings are for the purpose of describing selected versions of the present invention and are not intended to limit the scope of the present invention.

The present invention may be referred to as an “Ergonomic Modular Video Game Controller” or in a related fashion. The invention is a video game controller 100 comprising mirrored left-hand and right-hand side components 200. The side components 200 are removably connectable at the center for most embodiments. Embodiments may further comprise an option bridge component 300, which is removably connectable to each side component 200 and physically separates them.

Each side component 200 comprises a casing 201, one or more directional inputs 202, a utility button 203, at least four finger buttons 204, and controller electronics. The typical embodiment further comprises electrical connection components and mechanical connection structures. In a typical embodiment, the front of the casing 201 houses the one or more directional inputs 202 and the utility button 203 within the upper or forward region of the front-facing surface, with the utility button 203 being closer to the center of a user’s body (opposite the hand side of the component 200 in question) The utility button 203 is not expected to be used during the course of normal gameplay, so its distance from the hand and/or other buttons is of reduced importance. Further, a typical embodiment will house a pair of directional inputs 202. One directional input will typically offer a digital or partially digital pad structure while the other will offer an analog joystick structure. Because they generally control the same directional elements of the game or other controller activity, a user is only expected to access and utilize the one with which they are most comfortable.

The rear facing surfaces of the side components 200 house the finger buttons 204. The expected embodiments assign one button 204 for each finger which will rest on the rear of the controller 100 side component 200. The casing 201 itself is a contoured shell structured to be held in the palm of the user’s hand corresponding to the component’s 200 designated side with the thumb of that hand resting on or near the one or more directional inputs at the front side of the component 200 and with each finger resting on one of the finger buttons 204 on the rear side of the component 200. Embodiments of the contoured structure can be sized to fit a “typical” hand or may be specialized to fit a specific hand requirements. Additionally, the controller’s electronics, which produce and transmit the signals to the gaming system and/or computer, are housed within each side component 200. For the typical embodiment, these controller electronics are configured to function in coordination with the controller electronics from the opposite side component. This may be facilitated by direct physical connection or a wireless connection with one or both of the controller electronics elements communicating with the gaming system or other relevant activities and applications (the “host” system). Other embodiments may configure the components to independently communicate directly with the host system.

Embodiments for the inside facing surface of each side component 200 (that is, the surface facing away from the assigned hand-side) will also typically comprise structural components which allow each side component 200 to be removably connectable to the opposite side component 200. The connecting structural components may include magnets, screws, tabs, clamps, brackets, bushings, or other components which removably attach in coordination with the opposite side. Embodiments may also allow for direct electronic connection with the opposite side component 200 using techniques such as surface contact pads or electronic connector pins. The typical embodiment will employ cylindrical dowel pins, self-lubricated sleeve bearings, magnets, strike plates, and pogo pin connectors which facilitate the removable connection with the opposite side component 200.

A modular feature of the device 100 also allows embodiments to optionally employ the use of a bridge component 300 between the side components 200. The bridge component 300 comprises a shell 301 and structural connection components. The bridge may also comprise of electrical connection components. The shell 301 is structured as an elongated, tube-like article which will separate the connected side components 200 while engaged, which helps maintain the positional integrity and stability of a smaller controller. Typically, the bridge shell 301 will be comprised of the same material as the side component shells 201. Alternate embodiments may allow for the bridge shell 301 to comprise a different material and/or have the bridge 300 further comprise weights to modify the physical effort necessary while employing the bridge (potentially facilitating exercise or improving comfort with reduced weight). Each end of the bridge component 300 will be structured to imitate the internal facing side of the opposite side component 200, allowing removable connection in the same fashion as directly connecting the two side components 200.

Embodiments may further comprise connective electronics to facilitate electronic connection between each side components’ controller electronics, including the electronically connective components at the side component 200 facing ends. The bridge component 300 may also allow the device 100 to mimic the control motions of a steering wheel or similar control features. Embodiments employing such features may further comprise sensors, such as gyroscopes, alongside the controller electronics of each side component 200 or integrated within the bridge 300 itself. The side components 200 and bridge 300 may further comprise LED lighting components and/or digital readouts for internal electronic information or information communicated through the host system.

Although the invention has been explained in relation to its preferred embodiment, it is to be understood that many other possible modifications and variations can be made without departing from the spirit and scope of the invention.

1. A video game controller device, the controller comprising:
a left-hand side component comprising a casing, one or more directional actuators, four finger buttons, a utility button, control circuitry, and a transmitter; and
a right-hand side component comprising a casing, one or more directional actuators, four finger buttons, a utility button, control circuitry, and a transmitter;
wherein
the casing of each side component mirrors the other side component and comprises a cavity in which their respective control circuitry and transmitters are housed;
each casing is formed as a contoured shape with a grip on the bottom end with front facing, rear facing, and inside facing surfaces on the upper end;
the front facing surface of each casing comprises extrusions through which protrude the utility button and the one or more directional actuators;
the rear facing surface of each casing comprises extrusions through which protrude the four finger buttons;
the utility button, one or more directional actuators, and four finger buttons of each side component are electro-mechanically attached to the control circuitry within the cavity;
the control circuitry of each side component is configured to be electronically in communication with the transmitter of that side component;
the inside facing surface of each side component comprises an attachment point configured to be removably, physically coupled with the inside facing surface of the opposite side component;
the attachment point of each side component is electronically connected to the transmitter of that side component;
the attachment point of each side component comprises electronic connection points which are electronically coupled with the connection point of the opposite side component while the components are physically coupled; and
the transmitters are configured to coordinate electronic communications of the controller input to a host device.

2. The device of claim 1, wherein the grip, the one or more directional actuators, and the four finger buttons of each side component are arranged at points on the casing surface in an ergonomic fashion such that grip fits within a palm, the one or more directional actuators are positioned to where a thumb would rest, and the four finger buttons are each positioned where a different digit would rest for a commensurately sized human hand holding the side component comfortably during use.

3. The device of claim 1, wherein the one or more directional actuators are two actuators comprising a digital directional pad and an analog thumb stick.

4. The device of claim 3, wherein directional pad and thumb stick each also comprise button mechanisms independent of their directional control activity.

5. The device of claim 1, wherein the control circuitry further comprises one or more physical sensors and is configured to provide motion data to the control circuitry of the opposing side component and host device.

6. The device of claim 1, wherein the transmitters are configured to communicate with the host device through a wired physical connection.

7. The device of claim 1, wherein the transmitters of each side component communicate with one another through a wireless component.

8. The device of claim 7, wherein the transmitters are configured to communicate with the host device in coordination through a wireless connection.

9. A video game controller device, the controller comprising:
a left-hand side component comprising a casing, one or more directional actuators, four finger buttons, a utility button, control circuitry, and a transmitter;
a right-hand side component comprising a casing, one or more directional actuators, four finger buttons, a utility button, control circuitry, and a transmitter; and
a bridge component comprising a casing and bridge circuitry;
wherein
the casing of each side component mirrors the other side component and comprises a cavity in which their respective control circuitry and transmitters are housed;
each side component casing is formed as a contoured shape with a grip on the bottom end with front facing, rear facing, and inside facing surfaces on the upper end;
the front facing surface of each side component casing comprises extrusions through which protrude the utility button and the one or more directional actuators;
the rear facing surface of each side component casing comprises extrusions through which protrude the four finger buttons;
the utility button, one or more directional actuators, and four finger buttons of each side component are electro-mechanically attached to the control circuitry within the cavity;
the control circuitry of each side component is configured to be electronically in communication with the transmitter of that side component;
the inside facing surface of each side component comprises an attachment point configured to be removably physically coupled with an end of the bridge component casing corresponding to that side component;
the attachment point of each side component is electronically connected to the transmitter of that side component;
the attachment point of each side component comprises electronic connection points which are electronically coupled with the connection point of the opposite side component while the components are physically coupled;
the bridge component casing comprises a left-hand side facing end and a right-hand side facing end;
each side facing end of the bridge component comprises an attachment point configured to be removably, physically coupled with the inside facing surface corresponding to its respective side component;
the attachment points of the bridge component comprise electronic connection points which are electronically coupled with the connection point of an attached side component while the components are physically coupled;
the bridge circuitry is connected between the electronic connection points of each attachment point such that each of the side components are electronically connected to one another while both side components are electronically coupled with the bridge component; and
the transmitters are configured to coordinate electronic communications of the controller input to a host device.

10. The device of claim 9, wherein the grip, the one or more directional actuators, and the four finger buttons of each side component are arranged at points on the casing surface in an ergonomic fashion such that grip fits within a palm, the one or more directional actuators are positioned to where a thumb would rest, and the four finger buttons are each positioned where a different digit would rest for a commensurately sized human hand holding the side component comfortably during use.

11. The device of claim 10, wherein the device forms to roughly shoulder width while the bridge component is coupled with each side component.

12. The device of claim 9, wherein the one or more directional actuators are two actuators comprising a digital directional pad and an analog thumb stick.

13. The device of claim 12, wherein directional pad and thumb stick each also comprise button mechanisms independent of their directional control activity.

14. The device of claim 9, wherein the control circuitry further comprises one or more physical sensors and is configured to provide motion data to the control circuitry of the opposing side component and host device.

15. The device of claim 14, wherein the bridge component further comprises one or more bridge physical sensors, the one or more bridge physical sensors are electronically connected with the bridge circuitry, and motion data from the one or more bridge physical sensors is provided to the control circuitry of the side components and host device.

16. The device of claim 9, wherein the attachment points at each end of the bridge component are configured to be attached to the attachment points of either side component.

17. A video game controller device, the controller comprising:
a left-hand side component comprising a casing, one or more directional actuators, four finger buttons, a utility button, control circuitry, and a wireless transmitter; and
a right-hand side component comprising a casing, one or more directional actuators, four finger buttons, a utility button, control circuitry, and a wireless transmitter;
wherein
the casing of each side component mirrors the other side component and comprises a cavity in which their respective control circuitry and transmitters are housed;
each casing is formed as a contoured shape with a grip on the bottom end with front facing and rear facing surfaces on the upper end;
the front facing surface of each casing comprises extrusions through which protrude the utility button and the one or more directional actuators;
the rear facing surface of each casing comprises extrusions through which protrude the four finger buttons;
the utility button, one or more directional actuators, and four finger buttons of each side component are electro-mechanically attached to the control circuitry within the cavity;
the control circuitry of each side component is configured to be electronically in communication with the transmitter of that side component;
the transmitter of each side component is in wireless communication with the transmitter of the opposite side component and a host device; and
the transmitters are configured to coordinate electronic communications of the controller input to a host device.

18. The device of claim 17, wherein the grip, the one or more directional actuators, and the four finger buttons of each side component are arranged at points on the casing surface in an ergonomic fashion such that grip fits within a palm, the one or more directional actuators are positioned to where a thumb would rest, and the four finger buttons are each positioned where a different digit would rest for a commensurately sized human hand holding the side component comfortably during use.

19. The device of claim 17, further comprising
a bridge component comprising a casing, a left-side facing attachment point, and a right-side facing attachment point;
wherein
each side component casing further comprises an inside facing surface toward the upper end of that side component casing further comprising an attachment point;
the right-side facing attachment point on the bridge component is configured to be removably coupled with the attachment point on the right-hand side component; and
the left-side facing attachment point on the bridge component is configured to be removably coupled with the attachment point on the left-hand side component.

20. The device of claim 19, further wherein the attachment points on the left-hand and right-hand side components are configured to also be removably coupled with the corresponding attachment point of the opposing side component.
